(19) United States
(12) Patent Application Publication
(10) Pub. No.: US 2012/0218257 A1
(43) Pub. Date: Aug. 30, 2012

(54) MOBILE ELECTRONIC DEVICE, VIRTUAL INFORMATION DISPLAY METHOD AND STORAGE MEDIUM STORING VIRTUAL INFORMATION DISPLAY PROGRAM

(75) Inventor: Shuhei HISANO, Yokohama-shi (JP)

(73) Assignee: KYOCERA CORPORATION, Koyoto (JP)

(21) Appl. No.: 13/400,891

(22) Filed: Feb. 21, 2012

(30) Foreign Application Priority Data
Feb. 24, 2011 (JP) 2011-039075

(51) Int. Cl. G09G 5/00; G06T 15/00

(52) U.S. Cl. 345/419; 345/633

(57) ABSTRACT

According to an aspect, a mobile electronic device includes a detecting unit, an imaging unit, a display unit, and a control unit. The control unit calculates, based on a first image in which a marker is taken by the imaging unit, a reference position that is a relative position of the real marker when seen from the mobile electronic device. When causing the display unit to display a second image taken by the imaging unit, the control unit calculates a predicted position that is a position at which the marker is predicted to exist in taking the second image, based on a position of the mobile electronic device acquired based on a result detected by the detecting unit in taking the first image, a position of the mobile electronic device acquired based on a result detected by the detecting unit in taking the second image, and the reference position.

### CROSS-REFERENCE TO RELATED APPLICATIONS

This application claims priority from Japanese Application No. 2011-039075, filed on Feb. 24, 2011, the content of which is incorporated by reference herein in its entirety.

### BACKGROUND OF THE INVENTION

1. Technical Field

The present disclosure relates to a mobile electronic device, a virtual information display method and a storage medium storing therein a virtual information display program.

2. Description of the Related Art

In these years, attention is focused on augmented reality (AR) techniques that enable to add further information on a real space image by processing the image on a computer. For one of methods of adding information to a real space image, such a method is known in which a visible marker (a virtual information tag) is provided in a real space, and the marker is detected by analyzing an image taken by an imaging device, thereby displaying an image that virtual information (additional information) is superimposed on the detected marker (for example, see KATO Hirokazu, and three others, “An Augmented Reality System and its Calibration based on Marker Tracking”, Transactions of the Virtual Reality Society of Japan, Vol.4, No.4, pp. 607-616, (1999))

However, in order to superimpose virtual information on the marker in the taken image, it is necessary that the marker is entirely included in the image. For example, when the orientation of the imaging device is changed and a part of the marker is out of the shooting area, the marker cannot be detected even though the taken image is analyzed, so that virtual information cannot be superimposed on the image for display.

For the foregoing reasons, there is a need for a mobile electronic device, a virtual information display method and a virtual information display program that enable to display virtual information at a position corresponding to a marker even though the marker is not entirely included in an image.

### SUMMARY

According to an aspect, a mobile electronic device includes a detecting unit, an imaging unit, a display unit, and a control unit. The detecting unit detects a change in a position and attitude of the mobile electronic device. The display unit displays an image taken by the imaging unit. The control unit calculates, based on a first image in which a marker placed at a certain position and having a predetermined size and form is taken by the imaging unit, a reference position that is a relative position of the real marker when seen from the mobile electronic device. When causing the display unit to display a second image taken by the imaging unit, the control unit calculates a predicted position that is a position at which the marker is predicted to exist in taking the second image, based on a position of the mobile electronic device acquired based on a result detected by the detecting unit in taking the first image, a position of the mobile electronic device acquired based on a result detected by the detecting unit in taking the second image, and the reference position, and superimpose virtual information corresponding to the marker at a position corresponding to the predicted position of the second image for display.

According to another aspect, a virtual information display method is executed by a mobile electronic device that includes a detecting unit, an imaging unit, and a display unit. The virtual information display method includes: taking a first image, in which a marker placed at a certain position and having a predetermined size and form is taken, by the imaging unit; detecting a first position of the mobile electronic device in taking the first image by the detecting unit; calculating, based on the first image, a reference position that is a relative position of the real marker when seen from the mobile electronic device; taking a second image by the imaging unit; displaying the second image on the display unit; detecting a second position of the mobile electronic device in taking the first image by the detecting unit; calculating a predicted position that is a position at which the marker is predicted to exist in taking the second image, based on the first position of the mobile electronic device, the second position of the mobile electronic device, and the reference position; and superimposing virtual information corresponding to the marker at a position corresponding to the predicted position of the second image for display.

According to another aspect, a non-transitory storage medium stores therein a virtual information display program. When executed by a mobile electronic device that includes a detecting unit, an imaging unit, and a display unit, the virtual information display program causes the mobile electronic device to execute: taking a first image, in which a marker placed at a certain position and having a predetermined size and form is taken, by the imaging unit; detecting a first position of the mobile electronic device in taking the first image by the detecting unit; calculating, based on the first image, a reference position that is a relative position of the real marker when seen from the mobile electronic device; taking a second image by the imaging unit; displaying the second image on the display unit; detecting a second position of the mobile electronic device in taking the first image by the detecting unit; calculating a predicted position that is a position at which the marker is predicted to exist in taking the second image, based on the first position of the mobile electronic device, the second position of the mobile electronic device, and the reference position; and superimposing virtual information corresponding to the marker at a position corresponding to the predicted position of the second image for display.

### BRIEF DESCRIPTION OF THE DRAWINGS

FIG. 1 is a front view of a mobile electronic device according to an embodiment;

FIG. 2 is a block diagram illustrating of the mobile electronic device;

FIG. 3 is a diagram illustrating an example of a marker;

FIG. 4 is a diagram illustrating an example of the marker included in an image taken by an imaging unit;

FIG. 5 is a diagram illustrating an example of a three-dimensional object displayed as virtual information;

FIG. 6 is a flowchart illustrating the procedures of a virtual information display process performed by the mobile electronic device;

FIG. 7 is a diagram illustrating an example in which a product to be purchased on online shopping is displayed as virtual information;

FIG. 8 is a diagram illustrating an example in which the position of a three-dimensional object is changed; and

FIG. 9 is a diagram illustrating an example in which the size of a three-dimensional object is changed.

### DETAILED DESCRIPTION

Exemplary embodiments of the present invention will be explained in detail below with reference to the accompanying drawings. It should be noted that the present invention is not limited by the following explanation. In addition, this disclosure encompasses not only the components specifically described in the explanation below, but also those which would be apparent to persons ordinarily skilled in the art, upon reading this disclosure, as being interchangeable with or equivalent to the specifically described components.

In the following description, a mobile phone is used to explain as an example of the mobile electronic device, however, the present invention is not limited to mobile phones. Therefore, the present invention can be applied to various types of devices, including but not limited to personal handyphone systems (PHS), personal digital assistants (PDA), portable navigation units, personal computers (including but not limited to tablet computers, netbooks etc.), media players, portable electronic reading devices, and gaming devices.

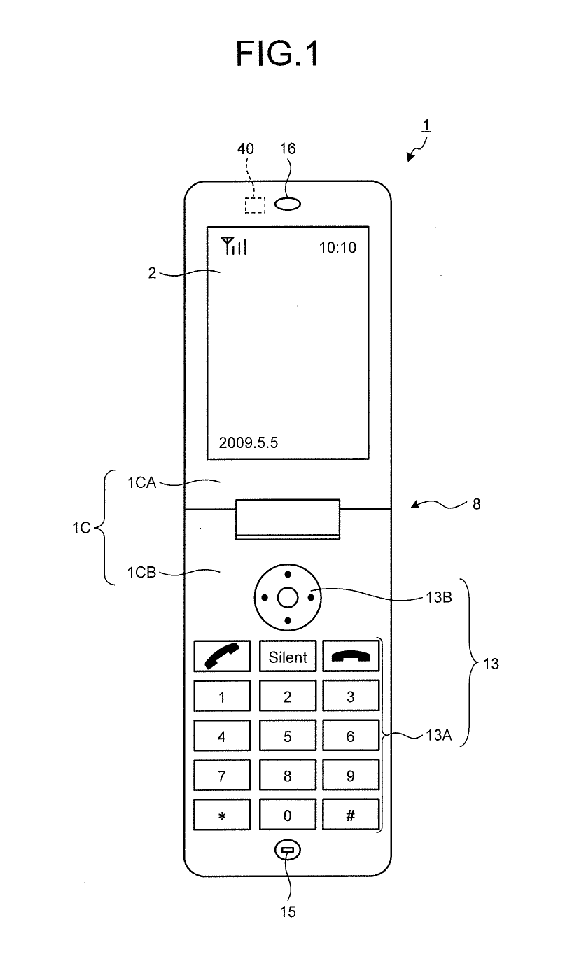

First, an overall configuration of a mobile electronic device 1 according to an embodiment will be described with reference to FIG. 1. FIG. 1 is a front view of the mobile electronic device 1. As illustrated in FIG. 1, a housing 1C of the mobile electronic device 1 includes a first housing 1CA and a second housing 1CB openably and closely joined to each other with a hinge mechanism 8. Namely, the mobile electronic device 1 has a foldable housing.

It is noted that the housing of the mobile electronic device 1 is not limited to such a structure. For example, the housing of the mobile electronic device 1 may be a slidable housing in which one housing can slide over the other housing from a state in which both housings are laid on each other, may be a rotatable housing in which one housing is rotated about an axis along a direction in which housings are laid on each other, or may be a housing in which two housings are joined to each other through a two-axis hinge. The housing of the mobile electronic device 1 may be a so-called straight (slate) housing formed of a single housing.

The first housing 1CA includes a display unit 2, a receiver 16, and an imaging unit 40. The display unit 2 includes a display device such as a liquid crystal display (LCD) and an organic electro-luminescence display (OELD), and displays various items of information such as characters, graphics, and images. The display unit 2 can also display an image taken by the imaging unit 40. The receiver 16 outputs voices of a person to whom a caller talks in conversations.

The imaging unit 40 takes an image by an image unit such as an imaging sensor. A shooting window that guides external light to the image unit of the imaging unit 40 is provided on a surface opposite to a surface on which the display unit 2 of the first housing 1CA is provided. Namely, the first housing 1CA is configured in such a way that, when a user sees the display unit 2 from the front side, an image on the opposite side of the first housing 1CA taken by the imaging unit 40 is displayed on the display unit 2.

The second housing 1CB includes an operation key 13A constituted of a ten key pad, function keys, and the like, a direction and enter key 13B to carry out selection and determination of a menu, scrolling a screen, and the like, and a microphone 15 that is a sound acquiring unit to acquire sounds in conversations. The operation key 13A and the direction and enter key 13B constitute an operation unit 13 of the mobile electronic device 1. The operation unit 13 may include a touch sensor superimposed on the display unit 2, instead of the operation key 13A and the like, or in addition to the operation key 13A and the like.

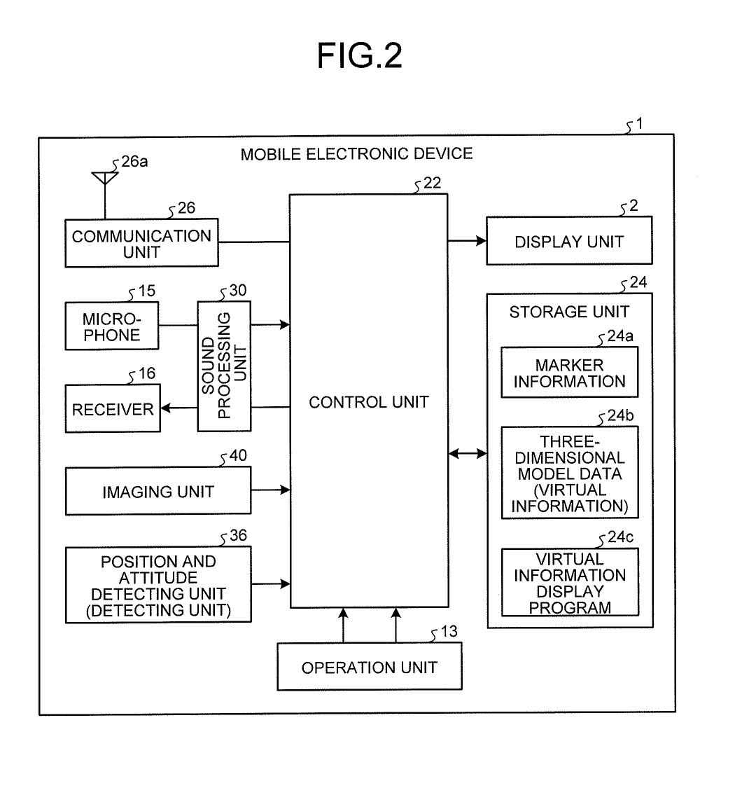

Next, the functional configuration of the mobile electronic device 1 will be described with reference to FIG. 2. FIG. 2 is a block diagram illustrating of the mobile electronic device 1. As illustrated in FIG. 2, the mobile electronic device 1 includes a communication unit 26, the operation unit 13, a sound processing unit 30, the display unit 2, the imaging unit 40, a position and attitude detecting unit (a detecting unit) 36, a control unit 22, and a storage unit 24.

The communication unit 26 has an antenna 26a. The communication unit 26 establishes a wireless signal path using a code-division multiple access (CDMA) system, or any other wireless communication protocols, with a base station via a channel allocated by the base station, and performs telephone communication and information communication with the base station. Any other wired or wireless communication or network interfaces, e.g., LAN, Bluetooth, Wi-Fi, NFC (Near Field Communication) may also be included in lieu of or in addition to the communication unit 26. The operation unit 13 outputs a signal corresponding to the content of the operation to the control unit 22 when the operation key 13A or the direction and enter key 13B is operated by the user.

The sound processing unit 30 converts a sound input from the microphone 15 into a digital signal, and outputs the digital signal to the control unit 22. Moreover, the sound processing unit 30 decodes the digital signal output from the control unit 22, and outputs the decoded signal to the receiver 16. The display unit 2 displays various items of information according to a control signal inputted from the control unit 22. The imaging unit 40 converts a taken image into a digital signal, and outputs the digital signal to the control unit 22.

The position and attitude detecting unit (the detecting unit) 36 detects a change in the position and attitude of the mobile electronic device 1, and outputs the detected result to the control unit 22. The position means coordinates, on a predetermined XYZ coordinate space, at which the mobile electronic device 1 exists. The attitude means the amount of rotation in directions, the X-axis direction, the Y-axis direction, and the Z-axis direction, on the aforementioned XYZ coordinate space, that is, an orientation and a tilt. The position and attitude detecting unit 36 includes a triaxial acceleration sensor, for example, to detect a change in the position and attitude of the mobile electronic device 1. The position and attitude detecting unit 36 may include a Global Positioning System (GPS) receiver and/or an orientation sensor, instead of the triaxial acceleration sensor, or in addition to the triaxial acceleration sensor.

The control unit 22 includes a Central Processing Unit (CPU) that is a computing unit and a memory that is a storing unit, and implements various functions by executing a program using these hardware resources. More specifically, the control unit 22 reads a program and data stored in the storage unit 24, loads the program and data on the memory, and causes the CPU to execute an instruction included in the program loaded on the memory. The control unit 22 then reads or writes data to the memory and the storage unit 24 according to the executed result of the instruction by the CPU, or controls the operation of the communication unit 26, the display unit 2, or the like. In executing the instruction by the CPU, data loaded on the memory, the signal inputted from the position and attitude detecting unit 36, or the like is used for a parameter.

The storage unit 24 includes one or more non-transitory storage medium, for example, a nonvolatile memory (such as ROM, EPROM, flash card etc.) and/or a storage device (such as magnetic storage device, optical storage device, solid-state storage device etc.). The programs and data to be stored in the storage unit 24 include a marker information 24a, a three-dimensional model data 24b, and a virtual information display program 24c. It is noted that these programs and data may be acquired from another device such as a server via wireless communications by the communication unit 26. Moreover, the storage unit 24 may be configured by combining a portable storage medium such as a memory card or the like and a read/write device to read and write data from/to the storage medium.

The marker information 24a holds information about the size and form of a marker provided in the real world. The marker is an article used as a mark indicative of a location where virtual information is superimposed in a captured real space image; the marker is a square card having a predetermined size, for example. The marker information 24a may include a template image to detect the marker by matching from an image taken by the imaging unit 40.

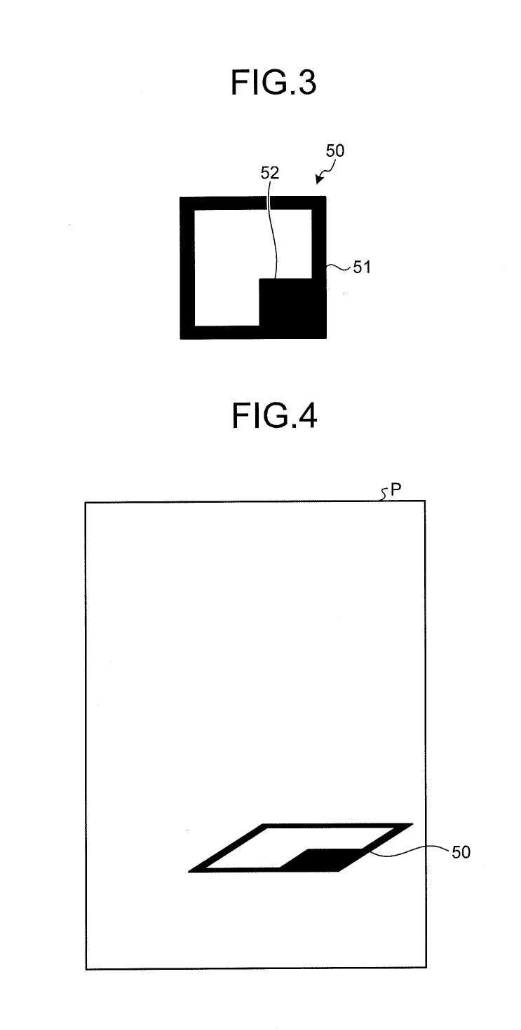

FIG. 3 is a diagram illustrating an example of the marker. A marker 50 illustrated in FIG. 3 is a square card having a predetermined size, and provided with a border 51 having a predetermined width along the outer circumference. The border 51 is provided for facilitating detection of the size and form of the marker 50. Furthermore, a rectangle 52 is drawn at one corner of the marker 50. The rectangle 52 is used for identifying the front of the marker 50. It is noted that the marker 50 is not necessarily formed in such a form, and sufficiently has a form such that the position, the size, and the form thereof can be determined in a taken image.

FIG. 4 is a diagram illustrating an example of the marker 50 included in an image P taken by the imaging unit 40. In the example illustrated in FIG. 4, the marker 50 is positioned at the lower right of the image P taken by the imaging unit 40, having width slightly wider than a half of the width of the image P, and transformed into a trapezoid. The position, size, and form of the marker 50 in the image P are changed depending on the relative position and attitude of the real marker 50 seen from the mobile electronic device 1. In other words, the relative position and attitude of the real marker 50 seen from the mobile electronic device 1 can be calculated from the position, size, and form of the marker 50 in the image P.

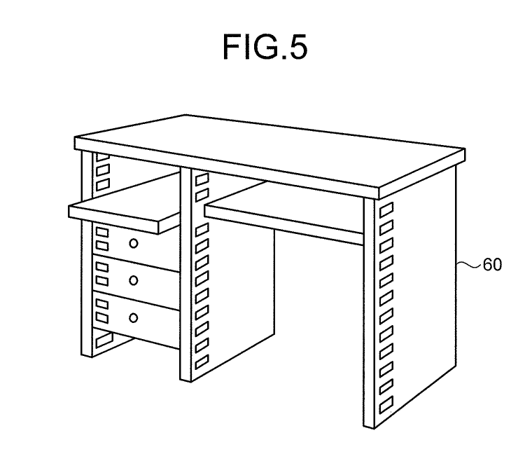

The three-dimensional model data 24b is data for creating a three-dimensional object to be displayed as virtual information in association with the marker defined by the marker information 24a. The three-dimensional model data 24b includes information about the position, size, color, or the like of the individual surfaces for creating a three-dimensional object 60 of a desk as illustrated in FIG. 5, for example. The three-dimensional object created based on the three-dimensional model data 24b is changed in the size and the attitude as matched with the position and attitude of the marker, converted into a two-dimensional image, and then superimposed on an image taken by the imaging unit 40. It is noted that information displayed as virtual information is not limited to a three-dimensional object, which may be a text, a two-dimensional image, or the like.

The virtual information display program 24c superimposes virtual information defined by the three-dimensional model data 24b on the image taken by the imaging unit 40 as if the virtual information actually exists at a position at which the marker is provided, and causes the display unit 2 to display the image on which the virtual information is superimposed. The virtual information display program 24c first causes the control unit 22 to calculate the position and attitude of the real marker based on the image taken by the imaging unit 40 and the marker information 24a. Thereafter, the virtual information display program 24c causes the control unit 22 to predict the position and attitude of the real marker based on the result detected by the position and attitude detecting unit 36. Thus, Once the position and attitude of the marker are determined with the image taken by the imaging unit 40, the mobile electronic device 1 can superimpose virtual information at a position at which the marker is provided for display, even when the entire marker is not included in the image taken by the imaging unit 40.

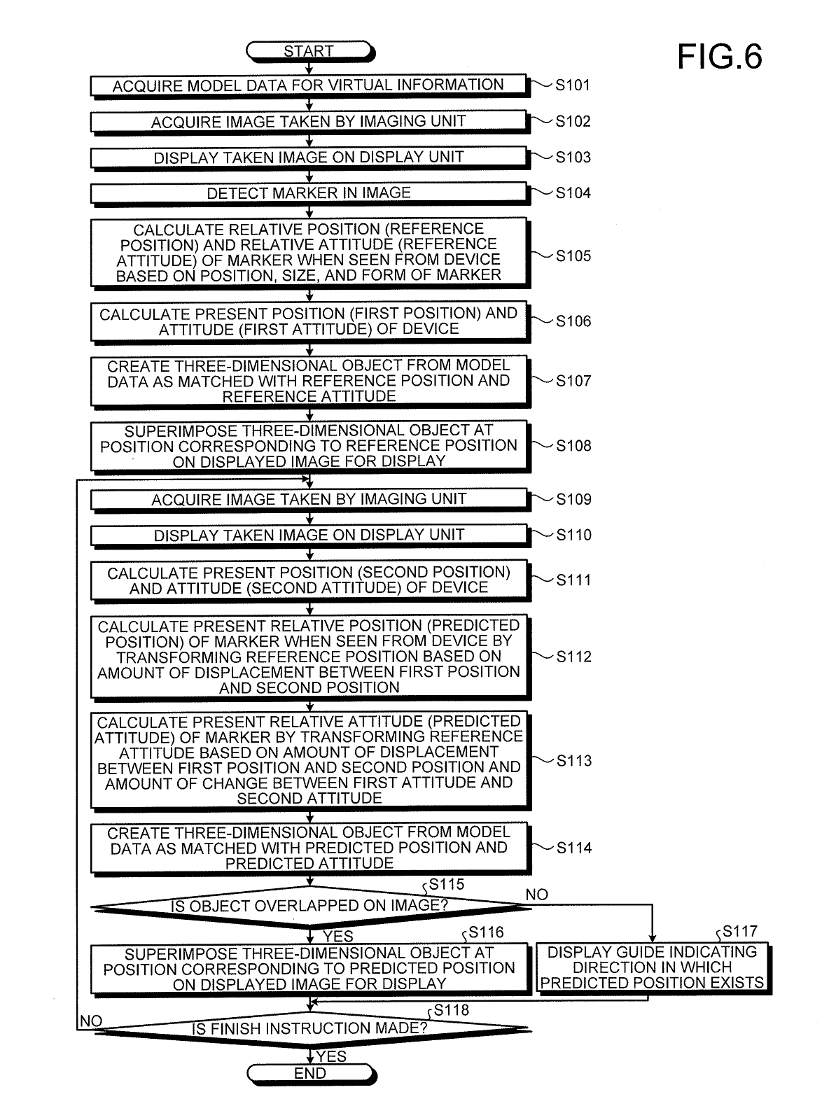

Next, the operation of the mobile electronic device 1 will be described with reference to FIG. 6. FIG. 6 is a flowchart illustrating the procedures of a virtual information display process performed by the mobile electronic device 1. The procedures of the process illustrated in FIG. 6 are implemented by the control unit 22 executing the virtual information display program 24c.

As illustrated in FIG. 6, the control unit 22 first acquires model data to be displayed as virtual information from the three-dimensional model data 24b at Step S101. The control unit 22 then acquires an image taken by the imaging unit 40 at Step S102, and causes the display unit 2 to display the taken image on at Step S103.

Subsequently, the control unit 22 detects a marker in the image taken by the imaging unit 40 based on the marker information 24a at Step S104. The detection of the marker may be implemented by matching the image taken by the imaging unit 40 with a template generated according to the form and the like defined in the marker information 24a, for example. Alternatively, such a configuration may be possible in which the user is caused to take the marker in such a way that the marker is included in a predetermined area of an image taken by the imaging unit 40 and the outline is extracted as by banalizing the inside of the predetermined area for detecting the marker.

Subsequently, the control unit 22 calculates the reference position and reference attitude of the marker based on the size and form of the marker defined in the marker information 24a and the position, size, and form of the marker in the image at Step S105. The reference position means the relative position of the actual marker when seen from the mobile electronic device 1 at a point in time at which the image is taken at Step S102. The reference attitude means the relative attitude of the actual marker when seen from the mobile electronic device 1 at a point in time at which the image is taken at Step S102. The reference position and the reference attitude can be calculated using a technique described in “An Augmented Reality System and its Calibration based on Marker Tracking”, by KATO Hirokazu, and three others, Transactions of the Virtual Reality Society of Japan, Vol.4, No.4, pp. 607-616, (1999), for example, described above.

Subsequently, at Step S106, the control unit 22 calculates a first position that is the position of the mobile electronic device 1 at the present point in time (at a point in time at which the image is taken at Step S102) and a first attitude that is the attitude of the mobile electronic device 1 at the present point in time based on the result detected by the position and attitude detecting unit 36.

Subsequently, at Step S107, the control unit 22 creates a three-dimensional object having the size matched with the reference position and the attitude matched with the reference attitude based on the model data acquired at Step S101. The size matched with the reference position means the size in the image taken by the imaging unit 40 when the three-dimensional object in the size defined in the model data actually exists at the reference position. The attitude matched with the reference attitude means the attitude calculated from the reference attitude based on a predetermined correspondence between the attitude of the marker and the attitude of the model data.

At Step S108, the control unit 22 then superimposes the three-dimensional object created at Step S107 at a position corresponding to the reference position of the image displayed on the display unit 2 for display. Preferably, the three-dimensional object is disposed in such a way that any one point on the bottom face or on a plane which the bottom face is extended is matched with the reference position. The three-dimensional object is disposed in this manner, so that such an image can be obtained in a state in which the three-dimensional object is placed on the marker.

As described above, the three-dimensional object is displayed as matched with the reference position and the reference attitude, so that it is possible to obtain an image as if the three-dimensional object exists at a position at which the marker is detected.

Subsequently, the control unit 22 acquires the subsequent image taken by the imaging unit 40 at Step S109, and causes the display unit 2 to display the taken image at Step S110. Subsequently, at Step S111, the control unit 22 calculates a second position that is the position of the mobile electronic device 1 at the present point in time (at a point in time at which the image is taken at Step S109) and a second attitude that is the attitude of the mobile electronic device 1 at the present point in time, based on the result detected by the position and attitude detecting unit 36.

At Step S112, the control unit 22 then calculates the predicted position of the actual marker by transforming the reference position based on the amount of the displacement between the first position and the second position. The predicted position of the marker means the relative position of the actual marker at the present point in time (at a point in time at which the image is taken at Step S109) when seen from the mobile electronic device 1. The transformation is implemented using a transformation matrix, for example.

Moreover, at Step S113, the control unit 22 calculates the predicted attitude of the actual marker by transforming the reference attitude based on the amount of the displacement between the first position and the second position and the amount of a change between the first attitude and the second attitude. The predicted attitude means the relative attitude of the actual marker at the present point in time (at a point in time at which the image is taken at Step S109) when seen from the mobile electronic device 1. The transformation is implemented using a transformation matrix, for example.

Subsequently, at Step S114, the control unit 22 creates a three-dimensional object having the size matched with the predicted position and the attitude matched with the predicted attitude based on the model data acquired at Step S101. The size matched with the predicted position means the size in the image taken by the imaging unit 40 when the three-dimensional object in the size defined in the model data actually exists at the predicted position. The attitude matched with the predicted attitude means the attitude calculated from the predicted attitude based on a predetermined correspondence between the attitude of the marker and the attitude of the model data.

Subsequently, at Step S115, the control unit 22 determines whether at least a part of the three-dimensional object is superimposed on the image when the three-dimensional object created at Step S114 is superimposed at the position corresponding to the predicted position of the image displayed on the display unit 2 for display.

When at least a part of the three-dimensional object is overlapped on the image (Step S115, Yes), the control unit 22 superimposes the three-dimensional object generated at Step S114 at the position corresponding to the predicted position of the image displayed on the display unit 2 for display at Step S116. Preferably, the three-dimensional object is disposed in such a way that any one point on the bottom face or on a plane that the bottom face is extended is matched with the predicted position.

When any part of the three-dimensional object is not overlapped on the image (Step S115, No), the control unit 22 superimposes a guide indicating a direction, in which the predicted position exists, near a position the closest to the predicted position in the image displayed on the display unit 2 for display at Step S117. An arrow, for example, indicating a direction in which the predicted position exists is displayed as the guide.

After thus superimposing the three-dimensional object or the guide on the image for display, the control unit 22 determines whether a finish instruction is accepted at the operation unit 13 at Step S118. When a finish instruction is not accepted (Step S118, No), the control unit 22 again carries out processes after Step S109. When a finish instruction is accepted (Step S118, Yes), the control unit 22 ends the virtual information display process.

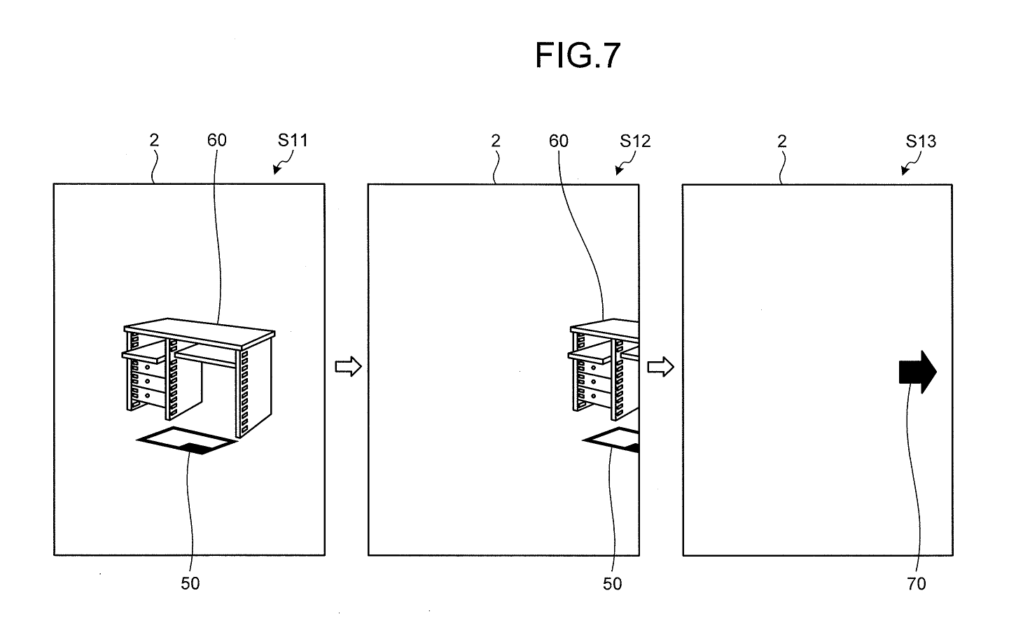

Next, a specific example of displaying virtual information by the mobile electronic device 1 will be described with reference to FIGS. 7 to 9. An example will be described in which prior to purchasing a desk on online shopping, the three-dimensional object 60 in the same form as a desk is displayed as virtual information in order to confirm a state in which the desk is placed in a room.

FIG. 7 is a diagram illustrating an example in which a product (a desk), which is to be purchased on online shopping, is displayed as virtual information. For pre-preparation for displaying the three-dimensional object 60 as virtual information, the user first downloads the three-dimensional model data 24b for creating the three-dimensional object 60 in the same form as the desk from an online shopping site, and stores the three-dimensional model data 24b in the storage unit 24 of the mobile electronic device 1. Moreover, the user places the marker 50 whose size and form are defined by the marker information 24a at a location where the desk is to be placed.

After completing such preparation, when the user starts the virtual information display program 24c by a selection from a menu screen or the like, the virtual information display process illustrated in FIG. 6 is started. When the user then takes the marker 50 in the image taken by the imaging unit 40, as illustrated at Step S11, the control unit 22 detects the marker 50 and displays the three-dimensional object 60 as matched with the position and attitude of the marker 50. As a result, an image in the inside of the room in which the three-dimensional object 60 of the desk is superimposed at the location where the desk is to be placed is displayed on the display unit 2. In this initial stage, the position, size and attitude of the three-dimensional object 60 are determined based on the position, size, and form of the marker 50 in the image taken by the imaging unit 40.

When the user changes the position or orientation of the mobile electronic device 1 from this state, the position, size and attitude of the three-dimensional object 60 are changed in the image displayed on the display unit 2. For example, when the user brings the mobile electronic device 1 closer to the marker 50, the three-dimensional object 60 is enlarged as well as the furniture or furnishings around the marker 50 are enlarged. Moreover, when the user changes the orientation of the mobile electronic device 1 to the left, the three-dimensional object 60 is moved to the right in the image as well as the furniture or furnishings around the marker 50 is moved to the right in the image.

As described above, the user changes the position or orientation of the mobile electronic device 1, so that it is possible to confirm the image in the inside of the room in the state in which the desk is placed at the location where the desk is to be placed from various viewpoints. It is also possible that the user confirms the image in the inside of the room in the state in which other types of desks are placed by changing the three-dimensional model data 24b to create the three-dimensional object 60.

In the stage in which viewpoints are variously changed as described above, the position, size and attitude of the three-dimensional object 60 are determined based on the position and attitude of the marker 50 predicted from the amount of the displacement in the position and the amount of a change in the attitude of the mobile electronic device 1. Thus, as illustrated at Step S12, even in a state in which the orientation of the mobile electronic device 1 is changed to the left and the marker 50 is not entirely included in the image taken by the imaging unit 40, the three-dimensional object 60 is superimposed at a position at which the marker 50 is placed for display.

When the orientation of the mobile electronic device 1 is then further changed to the left and the three-dimensional object 60 is out of the shooting area of the imaging unit 40, a guide 70 indicating a direction of the position at which the marker 50 is placed is displayed near the location the closest to the position at which the marker 50 is placed as illustrated at Step S13. Since the guide 70 is displayed as described above, it is possible that the user is prevented from losing track of the position at which the virtual information is displayed.

In FIG. 7, an example is illustrated in which the three-dimensional object 60 displayed as virtual information is confirmed from various viewpoints. However, such a configuration may be possible in which the aforementioned virtual information display process is modified to allow the position or size of the three-dimensional object 60 to be changed arbitrarily.

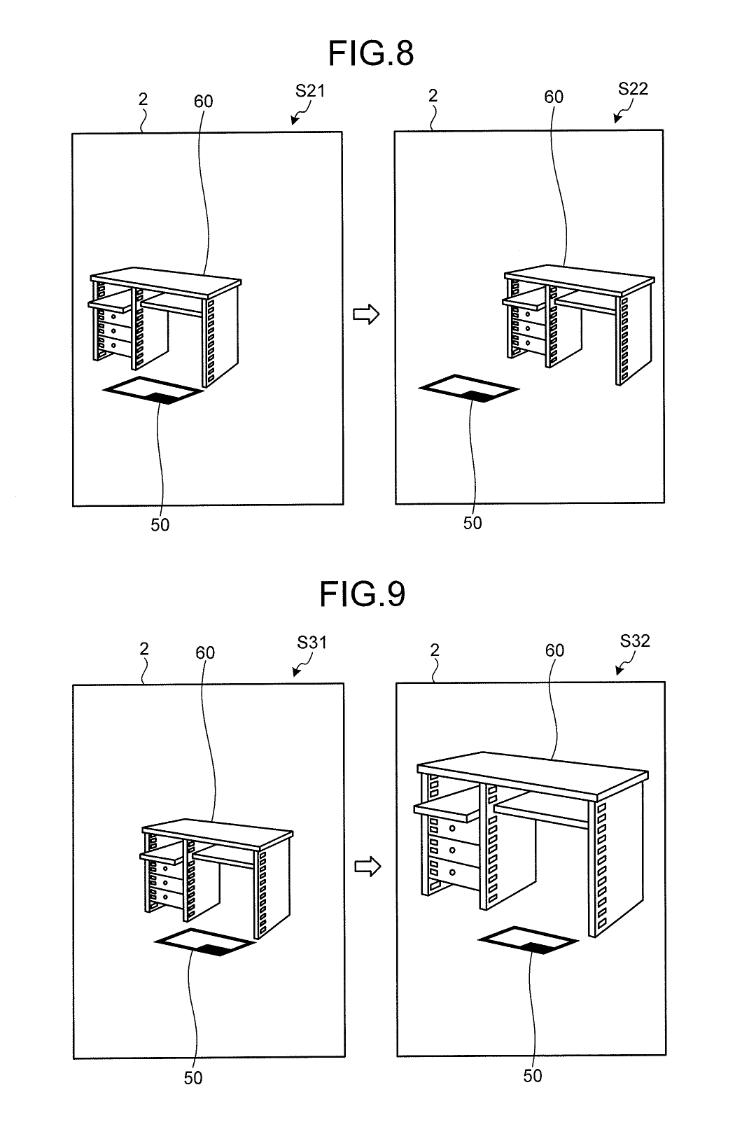

FIG. 8 is a diagram illustrating an example to change the position of the three-dimensional object 60. At Step S21 illustrated in FIG. 8, the marker 50 and the three-dimensional object 60 are positioned on the left in the image displayed on the display unit 2. Here, such a configuration may be possible in which in the case where a predetermined operation is made at the operation unit 13, the control unit 22 moves the position of the three-dimensional object 60 as matched with the operation.

At Step S22 illustrated in FIG. 8, the control unit 22 moves the position of the three-dimensional object 60 as matched with the operation, so that the three-dimensional object 60 is moved to the right in the image even though no change is observed at the position of the marker 50. As described above, the position at which the virtual information is displayed is changed according to the user making the operation, so that it is possible to readily confirm a state in which the marker 50 is placed at another position. This is convenient in the case of comparing a plurality of candidates for a location where the desk is placed with each other, for example. Changing the position of the three-dimensional object 60 is implemented by changing the amount of the offset of the position at which the three-dimensional object 60 is disposed with respect to the predicted position of the marker 50 according to the user making the operation, for example.

FIG. 9 is a diagram illustrating an example to change the size of the three-dimensional object 60. At Step S31 illustrated in FIG. 9, the three-dimensional object 60 is displayed in a normal size. Here, such a configuration may be possible in which in the case where a predetermined operation is made at the operation unit 13, the control unit 22 changes the size of the three-dimensional object 60 as matched with the operation.

At Step S32 illustrated in FIG. 9, the control unit 22 enlarges the three-dimensional object 60 as matched with the operation, so that the three-dimensional object 60 is displayed largely even though the position of the marker 50 is not changed. As described above, the size of virtual information to be displayed is changed according to the user making the operation, so that it is possible to change the display size of the three-dimensional object 60 without chaining the three-dimensional model data 24b to generate the three-dimensional object 60. This is convenient in the case of comparing states in which desks in different sizes are placed each other, for example. Changing the size of the three-dimensional object 60 is implemented by changing a coefficient to be multiplied on the three-dimensional object 60 according to the user making the operation, for example.

As described above, the mobile electronic device according to an aspect of the embodiment includes: a detecting unit configured to detect a change in a position and attitude of the mobile electronic device; an imaging unit; a display unit configured to display an image taken by the imaging unit; and a control unit configured to: calculate, based on a first image in which a marker placed at a certain position and having a predetermined size and form is taken by the imaging unit, a reference position that is a relative position of the real marker when seen from the mobile electronic device; and calculate, when causing the display unit to display a second image taken by the imaging unit, a predicted position that is a position at which the marker is predicted to exist in taking the second image, based on a position of the mobile electronic device acquired based on a result detected by the detecting unit in taking the first image, a position of the mobile electronic device acquired based on a result detected by the detecting unit in taking the second image, and the reference position, and superimpose virtual information corresponding to the marker at a position corresponding to the predicted position of the second image for display.

The virtual information display method according to an aspect of the embodiment is executed by a mobile electronic device that includes a detecting unit, an imaging unit, and a display unit. The includes virtual information display method includes: taking a first image, in which a marker placed at a certain position and having a predetermined size and form is taken, by the imaging unit; detecting a first position of the mobile electronic device in taking the first image by the detecting unit; calculating, based on the first image, a reference position that is a relative position of the real marker when seen from the mobile electronic device; taking a second image by the imaging unit; displaying the second image on the display unit; detecting a second position of the mobile electronic device in taking the first image by the detecting unit; calculating a predicted position that is a position at which the marker is predicted to exist in taking the second image, based on the first position of the mobile electronic device, the second position of the mobile electronic device, and the reference position; and superimposing virtual information corresponding to the marker at a position corresponding to the predicted position of the second image for display.

The virtual information display program according to an aspect of the embodiment causes, when executed by a mobile electronic device that includes a detecting unit, an imaging unit, and a display unit, the mobile electronic device to execute: taking a first image, in which a marker placed at a certain position and having a predetermined size and form is taken, by the imaging unit; detecting a first position of the mobile electronic device in taking the first image by the detecting unit; calculating, based on the first image, a reference position that is a relative position of the real marker when seen from the mobile electronic device; taking a second image by the imaging unit; displaying the second image on the display unit; detecting a second position of the mobile electronic device in taking the first image by the detecting unit; calculating a predicted position that is a position at which the marker is predicted to exist in taking the second image, based on the first position of the mobile electronic device, the second position of the mobile electronic device, and the reference position; and superimposing virtual information corresponding to the marker at a position corresponding to the predicted position of the second image for display.

According to these configurations, after the reference position of the marker is acquired, the position of the marker is predicted based on a change in the position of the mobile electronic device 1, and the virtual information is displayed at the position on the image corresponding to the predicted position. Thus, it is possible to display virtual information at a position corresponding to a marker even though the marker is not entirely included in an image.

According to another aspect of the embodiment, the control unit superimposes the virtual information at a position corresponding to the predicted position of the second image in size matched with the predicted position for display when causing the display unit to display the second image.

According to the configuration, the size of the virtual information is changed according to the predicted position of the marker. Thus, it is possible to display virtual information as if the virtual information exists.

According to another aspect of the embodiment, the control unit calculates a reference attitude that is a relative attitude of the real marker when seen from the mobile electronic device based on the first image, and when causing the display unit to display the second image, the control unit calculates a predicted attitude of the marker in taking the second image based on a position and attitude of the mobile electronic device acquired based on a result detected by the detecting unit in taking the first image, a position and attitude of the mobile electronic device acquired based on a result detected by the detecting unit in taking the second image, and the reference attitude, and the control unit superimposes the virtual information whose attitude is set based on the predicted attitude at a position corresponding to the predicted position of the second image for display.

According to the configuration, the attitude of the marker is further predicted, and the virtual information whose the attitude is set based on the predicted attitude of the marker is displayed. Thus, it is possible to display virtual information as if the virtual information exists.

According to another aspect of the embodiment, when the predicted position is at a position at which the virtual information is not superimposed on the second image, the control unit causes the display unit to display a guide indicating a direction in which the predicted position exists.

According to the configuration, the guide indicating the position, at which the virtual information is to be displayed, is displayed. Thus, it is possible that the user is prevented from losing track of the position of virtual information.

According to another aspect of the embodiment, the mobile electronic device further includes an operation unit configured to accept an operation, and the control unit changes the virtual information according to an operation accepted by the operation unit for display. For example, the control unit may change the size of the virtual information according to an operation accepted by the operation unit for display. For example, the control unit may change a position of the virtual information according to an operation accepted by the operation unit for display.

According to the configuration, it is possible that the user freely changes the position, size, or the like of virtual information for display, without changing the position of the marker to again acquire the reference position or without changing data to be displayed as virtual information.

According to another aspect of the embodiment, the mobile electronic device further includes a communication unit configured to communicate with an apparatus, and the control unit acquires the virtual information from the apparatus via communications by the communication unit.

According to the configuration, it is possible that the user displays various items of virtual information acquired from the apparatus via communications.

According to another aspect of the embodiment, the virtual information is a three-dimensional object created based on three-dimensional model data, and when superimposing the virtual information on the second image for display, the control unit creates the virtual information based on the three-dimensional model data acquired in advance.

According to the configuration, it is unnecessary to again acquire three-dimensional model data every time when virtual information is again displayed. Thus, it is possible to suppress the delay of the process of displaying virtual information and an increase in the load of the mobile electronic device.

It is noted that the mode of the present invention in the aforementioned embodiment can be appropriately modified and altered in the scope not departing from the spirit of the present invention. For example, in the aforementioned embodiment, an example is described in which a single item of virtual information is displayed. However, it may be possible to display a plurality of items of virtual information. In this case, the reference position and reference attitude of a marker corresponding to each of the items of virtual information may be acquired collectively based on a single image, or may be acquired by taking an image for every marker.

In the aforementioned embodiment, the reference position and the reference attitude are acquired only once initially based on the image taken by the imaging unit 40. However, the reference position and the reference attitude may be again acquired. For example, such a configuration may be possible in which when the marker is detected in a predetermined area in the center of an image taken by the imaging unit 40, the reference position and the reference attitude are again acquired based on the image. With this configuration, it is possible to correct a shift when the position and attitude of the mobile electronic device 1 calculated based on the result detected by the position and attitude detecting unit 36 are shifted from the actual position and attitude. Furthermore, the portion near the center of the image with a small distortion is used, so that it is possible to highly accurately correct the shift.

In the aforementioned embodiment, an example is described in which the three-dimensional object is displayed as virtual information. However, a two-dimensional object expressing characters, graphics, or the like on a plane may be displayed as virtual information. In this case, the two-dimensional object is superimposed on an image in such a way that the surface on which characters, graphics, or the like always faces to the imaging unit 4 regardless of the relative attitude of the actual marker 50 when seen from the mobile electronic device 1. Even when the three-dimensional object is displayed as virtual information, the three-dimensional object may be superimposed on the image in a state in which the three-dimensional object is seen from a specific direction all the time regardless of the relative attitude of the actual marker 50 when seen from the mobile electronic device 1.

Such a configuration may be possible in which in the case where an operation to select a displayed item of virtual information is detected by the operation unit 13, information corresponding to the selected item of virtual information is displayed on the display unit 2. For example, as illustrated in FIG. 7, when a product that is to be purchased on online shopping is displayed as virtual information, a Web page to purchase a product corresponding to the virtual information may be displayed on the display unit 2 when an operation to select the virtual information is detected.

Such a configuration may be possible in which a display unit capable of three-dimensional display with the naked eyes or with glasses is provided on the mobile electronic device 1 and virtual information is displayed three-dimensionally. In addition, such a configuration may be possible in which a three-dimensional scanner function is provided on the mobile electronic device 1 and a three-dimensional object acquired by the three-dimensional scanner function is displayed as virtual information.

The advantages according to one embodiment of the invention provides are that virtual information can be displayed at a position corresponding to a marker even though the marker is not entirely included in an image.

What is claimed is:

1. A mobile electronic device comprising:
a detecting unit configured to detect a change in a position and attitude of the mobile electronic device;
an imaging unit;
a display unit configured to display an image taken by the imaging unit; and
a control unit configured to:
calculate, based on a first image in which a marker placed at a certain position and having a predetermined size and form is taken by the imaging unit, a reference position that is a relative position of the real marker when seen from the mobile electronic device; and
calculate, when causing the display unit to display a second image taken by the imaging unit, a predicted position that is a position at which the marker is predicted to exist in taking the second image, based on a position of the mobile electronic device acquired based on a result detected by the detecting unit in taking the first image, a position of the mobile electronic device acquired based on a result detected by the detecting unit in taking the second image, and the reference position, and superimpose virtual information corresponding to the marker at a position corresponding to the predicted position of the second image for display.

2. The mobile electronic device according to claim 1,
wherein the control unit is configured to superimpose the virtual information at a position corresponding to the predicted position of the second image in size matched with the predicted position for display when causing the display unit to display the second image.

3. The mobile electronic device according to claim 1, wherein
the control unit is configured to:
calculate a reference attitude that is a relative attitude of the real marker when seen from the mobile electronic device based on the first image; and
calculate, when the causing display unit to display the second image, a predicted attitude of the marker in taking the second image based on a position and attitude of the mobile electronic device acquired based on a result detected by the detecting unit in taking the first image, a position and attitude of the mobile electronic device acquired based on a result detected by the detecting unit in taking the second image, and the reference attitude, and superimpose the virtual information whose attitude is set based on the predicted attitude at a position corresponding to the predicted position of the second image for display.

4. The mobile electronic device according to claim 1,
wherein the control unit is configured to cause the display unit to display a guide indicating a direction in which the predicted position exists when the predicted position is at a position at which the virtual information is not superimposed on the second image.

5. The mobile electronic device according to claim 1, further comprising
an operation unit configured to accept an operation,
wherein the control unit is configured to change the virtual information according to an operation accepted by the operation unit for display.

6. The mobile electronic device according to claim 5,
wherein the control unit is configured to change size of the virtual information according to an operation accepted by the operation unit for display.

7. The mobile electronic device according to claim 5,
wherein the control unit is configured to change a position of the virtual information according to an operation accepted by the operation unit for display.

8. The mobile electronic device according to claim 1, further comprising
a communication unit configured to communicate with an apparatus,
wherein the control unit is configured to acquire the virtual information from the apparatus via communications by the communication unit.

9. The mobile electronic device according to claim 1, wherein
the virtual information is a three-dimensional object created based on three-dimensional model data, and
the control unit is configured to create, when superimposing the virtual information on the second image for display, the virtual information based on the three-dimensional model data acquired in advance.

10. A virtual information display method executed by a mobile electronic device that includes a detecting unit, an imaging unit, and a display unit, the virtual information display method comprising:
taking a first image, in which a marker placed at a certain position and having a predetermined size and form is taken, by the imaging unit;
detecting a first position of the mobile electronic device in taking the first image by the detecting unit;
calculating, based on the first image, a reference position that is a relative position of the real marker when seen from the mobile electronic device;
taking a second image by the imaging unit;
displaying the second image on the display unit;
detecting a second position of the mobile electronic device in taking the first image by the detecting unit;
calculating a predicted position that is a position at which the marker is predicted to exist in taking the second image, based on the first position of the mobile electronic device, the second position of the mobile electronic device, and the reference position; and
superimposing virtual information corresponding to the marker at a position corresponding to the predicted position of the second image for display.

11. A non-transitory storage medium that stores a virtual information display program for causing, when executed by a mobile electronic device that includes a detecting unit, an imaging unit, and a display unit, the mobile electronic device to execute:
taking a first image, in which a marker placed at a certain position and having a predetermined size and form is taken, by the imaging unit;
detecting a first position of the mobile electronic device in taking the first image by the detecting unit;
calculating, based on the first image, a reference position that is a relative position of the real marker when seen from the mobile electronic device;
taking a second image by the imaging unit;
displaying the second image on the display unit;
detecting a second position of the mobile electronic device in taking the first image by the detecting unit;
calculating a predicted position that is a position at which the marker is predicted to exist in taking the second image, based on the first position of the mobile electronic device, the second position of the mobile electronic device, and the reference position; and
superimposing virtual information corresponding to the marker at a position corresponding to the predicted position of the second image for display.
